(19) United States
(12) Patent Application Publication
(10) Pub. No.: US 2009/0190463 A1
(43) Pub. Date: Jul. 30, 2009

(54) OPTICAL PICK-UP UNIT WITH TWO-MIRROR PHASE SHIFTER

(75) Inventors: Kim Leong Tan, Santa Rosa, CA (US); Curtis R. Hruska, Windsor, CA (US); Karen Denise Hendrix, Santa Rosa, CA (US)

Correspondence Address: Pequignot + Myers LLC, 140 Marine View Avenue, Suite 220, Solana Beach, CA, 92075, US

(73) Assignee: JDS Uniphase Corporation,, Milpitas, CA (US)

(21) Appl. No.: 12/362,219

(22) Filed: Jan. 29, 2009

Related U.S. Application Data
(60) Provisional application No. 61/024,715, filed on Jan. 30, 2008.

(51) Int. Cl. G11B 7/00

(52) U.S. Cl. 369/112.23

(57) ABSTRACT

Optical pick-up units (OPU), which require several light sources for reading newer formats, such as Blu-Ray, and legacy formats, such as DVD and CD, require a series of beam splitters/combiners for directing the various source light beams from the light sources along a common path. A two-mirror reflector sub-unit, in which at least one mirror includes a thin film dielectric retarder element, is used to redirect the beams traveling along the common path onto the disc-media, while imposing a 90° retardation onto the polarized light incidence, whereby light returning from the disc-media undergoes a 90° orientation change in the state of polarization from one linear polarization to the other orthogonal linear polarization.

### CROSS-REFERENCE TO RELATED APPLICATIONS

The present invention claims priority from U.S. Patent Application No. 61/024,715 filed Jan. 30, 2008, which is incorporated herein by reference for all purposes.

### TECHNICAL FIELD

The present invention relates to an optical pick-up unit of an optical storage and reader device, and in particular to a multi-format compatible optical pick-up unit including a two-mirror phase shifter and beam deflector.

### BACKGROUND OF THE INVENTION

The use of Compact Discs (CD) and Digital Versatile Discs (DVD) has become commonplace for optical storage and the transfer of data. Audio-CD and/or CD-ROM units have an optical pick-up unit (OPU), which uses a near-infrared (NIR), e.g., 780 nm, 785 nm, 790 nm, semiconductor laser to read-out the encoded digital information, and an objective lens with a numerical aperture (NA) of about 0.45, which enables a pit, i.e. one unit of encoding on a disc, measuring about 100 nm deep, 500 nm wide and 850 nm to 3500 nm long, depending on the radial distance from the disc center. The DVD format gains additional storage density by employing a shorter wavelength semiconductor (SC) laser, e.g. 650 nm or 660 nm, in the red band, (compared to the 780 nm NIR laser in audio-CD units) and a lens with a larger NA, e.g. 0.6 NA, requiring a 0.6 mm thick DVD disc. A backward compatible DVD/CD OPU employs two laser sources, either packaged as a single component or discretely, which have the read beams coupled by polarization beam combiners (PBCs) and/or dichroic beam combiners (DBCs).

The successor technology to the DVD media format is the Blu-ray Disc (BD), in which the read/write semiconductor (SC) laser wavelength is further decreased to about 405 nm to 410 nm, in the blue-violet band, and in which the NA of the objective lens is increased to about 0.85. In BD access systems which are backward compatible to DVD/CD formats, a third wavelength laser, e.g. co-packaged or discrete with respect to the first two lasers, is required to support all three disc media formats.

The conventional multi-channel OPU system utilizes a transmissive quarter wave plate (QWP) for converting linear polarization light in the source/detector segment to circular polarization in the disc read/write segment or v.v.

With reference to FIG. 1, a conventional three-wavelength BD/DVD/CD OPU 100 includes an array of semiconductor laser sources 110 illustrated as three discrete laser diodes (LD) including a first LD 111 at λ=780 nm, a second LD 112 at λ=660 nm, and a third LD 113 at λ=405 nm. The outputs of the first, second and third LD's 111, 112 and 113 are spatially multiplexed by an array 130 of polarization beam combiner cubes (PBC) 131, 132 and 133, respectively, and collimated by a lens system 160. The output beam is then redirected by a leaky mirror 140, which also acts as a vertical fold mirror, before being imaged (focused) onto a single “pit” area on the rotating disc media 150 via a QWP 145 and an objective lens 161. The leaky mirror 140 also enables a small fraction, e.g. 5%, of the incident beam energy to pass therethrough and be tapped off and focused onto a monitor photodiode (PD) 175 via another lens 165.

The output from the array 110 of LD sources is substantially linearly polarized, e.g. ‘S’ polarized, with respect to the hypotenuse surface of the PBC's 131, 132 and 133. Prior to reaching the array of PBC cubes 130, the linearly polarized beams are transmitted through an array of low-specification polarizers 120, which protect the LD sources 111, 112 and 113 from unwanted feedback, e.g. “P” polarized light. Conventionally, the protection filters 120 are simple dichroic absorptive polarizers with a 10:1 polarization extinction ratio.

The main ray from each of the LD sources 111, 112 or 113 is directed along the common path 180 towards the disc media 150. Prior to reaching the quarter-waveplate (QWP) 145, the light is substantially linearly polarized. After passing through the QWP 145, the linearly polarized (LP) light is transformed into circularly polarized (CP) light. The handedness of the CP light is dependent on the optic axis orientation of the QWP 145 for a given S- or P-polarized input. In the example shown, with ‘S’ polarization input to the QWP 145, if the slow-axis of the QWP 145 is aligned at 45° counter clockwise (CCW), with respect to the p-plane of the PBC 131, a left-handed circularly (LHC) polarized results at the exit of the QWP 145 (LHC, having a Jones vector [1 j]^{T}/√2 and with the assumption of intuitive RH-XYZ coordinate system while looking at the beam coming to the observer; superscript ‘T’ denotes matrix transpose).

In a pre-recorded CD and DVD disc, where there is a physical indentation of a recorded pit, the optical path length difference between the pit and the surrounding “land”, e.g. ⅙ to ¼ wave, provides at least partial destructive interference and reduces the light reflected back through the OPU 100 to be detected by a main photodiode 170 positioned at an output port of the PBC cube array 130. On the other hand, the absence of a pit causes the change of the CP handedness, at substantially the same light power in its return towards the PBC cube array 130. Accordingly, the light double-passed through the QWP 145 has effectively been transformed from the initially S-polarized light to P-polarized light on its return to the PBC array 130 enabling the light to pass through each of the PBS's 131, 132 and 133 to the main photodiode 170.

In the OPU system 100 illustrated in FIG. 1, the QWP 145 functions as a polarization converter by, in a first pass, transforming linearly polarized light having a first polarization state to circularly polarized light, and in a second pass, transforming circularly polarized light into linear polarized light having a second orthogonal polarization state. Conventionally, QWPs are formed from birefringent elements, such as inorganic crystals, e.g. single crystal quartz, single crystal MgF₂, LiNbO₃; liquid crystals; or stretched polymer films, e.g. polycarbonate, polyvinyl alcohol. Unfortunately, conventional QWPs only function efficiently within a small wavelength band.

Accordingly, OPU systems, such as those illustrated in FIG. 1, often use an achromatic QWP (AQWP), which provides quarterwave retardance at more than one wavelength band and/or over a relatively broad wavelength band. Conventionally, AQWPs are fabricated by laminating two or more different waveplates together, e.g. a half-waveplate layer and a quarter-waveplate layer, of two different index dispersion birefringent materials, such as quartz and MgF₂, bonded together with an adhesive with their optical axes orthogonal to one another, or of two or more layers of similar birefringent layers aligned with predetermined azimuthal angle offsets. However, while laminated AQWP structures do provide an increased bandwidth, they are also associated with poor environmental resistance. In addition, the use of two or more waveplate layers increases manufacturing costs of the AQWPs due to the required thickness and azimuthal angle offset tolerances.

With the current high density optical storage systems, i.e. one that includes a BD disc reading/writing channel, the reliability of the QWP element becomes a critical factor at high power blue-violet laser output, e.g., 240 mW or higher power for faster read/write speed. Furthermore, an AQWP for all three light channels, blue-violet 405 nm, red 660 nm and NIR 780 nm is required to produce approximately, 100 nm, 165 nm and 200 nm of retardation magnitudes. These disparate retardation magnitude requirements, obtained from a high reliability birefringent component and at a low cost for consumer electronic integration, drive the search of alternate QWP technology other than single crystalline materials and stretched organic foils. One solution involves separating the short wavelength blue-violet channel into a separate OPU with the legacy red/NIR DVD/CD channels in a conventional OPU, including a stretched foil AQWP. However, this approach increases costs due to the necessity of multiple redundant optical components, e.g. fold mirrors, lenses, etc.

In co-pending United States Patent Publication 2008/0049584, published Feb. 28, 2008 in the name of Tan et al, incorporated herein by reference, an alternate approach to realizing a linear to circular polarization conversion and vice versa is detailed. The OPU system in the Tan et al reference incorporates a thin-film reflective QWP (also called a QWP mirror) instead of a conventional transmissive QWP. An OPU system with an azimuthal angle skew of ±45 deg. between the light source segment and the disc media read/write segment is illustrated in FIG. 2. The OPU system 200, which has a configuration similar to the system 100 shown in FIG. 1, includes an array of light sources 210 including at least one light source 211, 212 and 213, an array of protection filters 220, an array 230 of polarization beam combiners (PBC) 231, 232 and 233, a reflector 240, a rotating optical disc 250, a collimating lens 260, an objective lens 261, a focusing lens 265, a main photodiode 270, and a monitor photodiode 275.

The array of light sources 210, provides linearly polarized light at one or more different wavelengths, e.g., at 780 nm, 660 nm, and 405 nm, respectively. Alternatively, the array of light sources 210 includes three co-packaged LDs. Alternatively, the array of light sources 210 includes more or less than three LDs.

The array of PBC 230, which include a first PBC 231, a second PBC 232, and a third PBC 233, is used to spatially multiplex the output from the array of LDs 210 and direct it along a common light path 280. In contrast to a traditional MacNeille-type PBC, which always reflects one polarization, e.g. S-pol., and transmits the orthogonal polarization, e.g. P-pol., the array of polarization beam combiners 230 are wavelength dependent. For example, in a forward propagating direction, the first PBC 231 couples light λ₁ from the first LD 211 to the common path 280 by reflecting S-polarized light at λ₁. In a backward propagating direction, the first PBC 231 transmits P-polarized light at λ₁, as well as transmitting the P-polarized light at λ₂ and λ₃, which are associated with LD 212 and 213, respectively. Similarly, PBC 232 couples light at λ₂ to the common path 280 by reflecting S-polarized light at λ₂ and transmitting P-polarized light at λ₁, λ₂ and λ₃ as well as transmitting S-polarized and at λ₁, while PBC 233 couples light at λ₃ to the common path 280 by reflecting S-polarized light at λ₃ and transmitting P-polarized light at λ₁, λ₂ and λ₃ as well as transmitting S-polarized light at λ₁ and λ₂.

The reflector 240 redirects light transmitted from the array of PBC 230 through a 90° beam folding to the rotating optical disc 250. The reflector 240 includes a thin film coating 292 that provides substantially quarterwave retardation for at least one wavelength channel, e.g. three wavelengths with approximately 405 nm, 660 nm and 780 nm for the OPU system shown in FIG. 3. According to one embodiment, the thin film coating 292 includes a plurality of alternating layers having contrasting refractive indices that are incorporated into a filter, e.g. short-wave pass or long-wave pass, band pass, high reflection, etc., and deposited on a transparent substrate. The transparent substrate may be a parallel plate or a near 45° prism, e.g. the thin film coating 292 may be deposited on the angled facet of a prism. In this embodiment, the filter 292 functions a leaky mirror and enables a small fraction, e.g. 5%, of the incident beam energy to pass through the reflector 240 and tapped off and focused onto the monitor photodiodes 275. In another embodiment, the high reflector 240 redirects substantially all incident light, S-pol. and P-pol., to the orthogonal beam path towards the optical disc 250.

The remaining optical components, including the collimating lens 260, the objective lens 261, the focusing lens 265, and the photodiodes (PD) 270, 275, are similar to those used in the prior art. Notably, the system 200 illustrated in FIG. 3 has been simplified to some extent for illustrative purposes. For example, in commercial OPUs the LD output is typically fanned-out to multiple spots, e.g. 3, for tracking the pit-lane, and auxiliary photodiode elements are mounted at the detector plane to determine the correct tracking. In addition, a photodiode array may be used in place of the main PD 270, to aid the objective lens focusing, in conjunction with cylindrical focusing lenses at the detector plane.

In operation, linearly polarized light from each LD 211, 212, 213 is transmitted as polarized light, e.g. S-polarized light, through the array of protection filters 220, is spatially multiplexed by the array of PBC 230, and is directed along common optical path 280. The linearly polarized light is then collimated by collimating lens 260, and transmitted to the leaky mirror 240 having the C-plate QWP coating 292. The leaky mirror 240 transforms the linearly polarized light into circularly polarized light and redirects it to the optical disc 250 via the objective lens 261. Light reflected by the optical disc 250 is retransmitted through the objective lens 261 and is reflected from the reflector 240 towards the collimating lens 260. After double passing/reflecting from the leaky mirror 240, the circularly polarized light is transformed again to linearly polarized light having a polarization state orthogonal to the incident light, e.g. will be P-polarized light. The array of PBC 230 passes the P-polarized light at each of the multiple wavelengths and directs the light to the main photodiode 270.

Notably, the performance of this optical system 200 is dependent on an angular offset between the components upstream of the reflector 240 and the components downstream of the reflector 240. To facilitate subsequent discussion about the azimuthal orientations of various system components, the optical systems 100/200 is schematically separated into a source/detector segment that provides beam multiplexing and read-out beam detection, and a disc read/write segment that collimates and relays the multiplexed beam to the optical disc media. Referring again to FIGS. 1 and 2, the source/detector segment may include the optical components to the left of output port of the PBC array 130/230, i.e. to the left of common path label 180/280, whereas the disc read/write segment may include the optical components to the right of the common path label 180/280. The collimating lens 160/260 may belong to either segment, depending on the location thereof. In general, the disc read/write segment will include the reflector 240 and/or the light beams that are substantially circularly polarized.

In one embodiment of the Tan et al invention, the source/detector segment has to be rotated about the common beam axis by ±45 deg. This azimuthal angle skewing allows for equal S-pol. and P-pol. illumination of the QWP mirror. It follows that the 90° phase retardance imparted by the QWP mirror converts the linear polarization input to a circular polarization output for accessing the encoded data on the disc media.

The need to rotate a prism array, i.e. polarization beam combiners and splitters, PBC, assembly and the associated LD array is not a practical one. The combined lateral dimension of the LD and PBC arrays extends to several tens of millimeters. Any out-of-plane rotation about the common beam axis, as is required by the ±45° skew angle, results in an increased vertical height for the packaged OPU system. In thin disc trays for computer notebook applications, the increased volume is not tolerated, e.g. less than 10 mm OPU height is typically required. Consequently, an alternate approach to imposing both a non-normal incidence, e.g. 45°, at the reflective QWP and the required ±45-deg. azimuthal angle difference between the incoming linear polarization and the P-plane of QWP mirror is desired.

An object of the present invention is to overcome the shortcomings of the prior art by maintaining the arrangement of the PBC array, the LD array and the associated optical components in a conventional OPU system along a first device plane, e.g. the horizontal plane, and by arrangement of the beam coupling elements orthogonal to first device plane, e.g. vertically directed, in order to access the disc media while enabling for the replacement of the transmissive QWP with a reflective QWP. In the conventional OPU layout, the 90° vertical fold mirror serves as the demarcation of the source/detector segment and the disc read/write segment. The vertical fold mirror is typically inclined at 45° vs. the horizontal plane. In the present invention, the vertical fold mirror is inclined at a non-45° angle. The transmissive QWP is removed, and replaced with a reflective QWP, positioned before the vertical fold mirror. The QWP mirror is arranged at a nominal 45° angle of incidence vs. the common beam path and with the plane of incidence of the QWP mirror arranged at ±45° azimuthal angle difference from the input linear polarization. The combination of two-stage beam folding with the QWP mirror and the vertical fold mirror converts a linearly polarized incoming beam, incident along the horizontal plane, to a circularly polarized output beam and deflects the beam from the horizontal plane to the vertical direction in order to access the disc media. Such an OPU layout utilizes a high reliability QWP reflector without the need to skew the azimuthal arrangement of major optical components in an OPU away from the first device plane.

### SUMMARY OF THE INVENTION

Accordingly, the present invention relates to an optical pick-up unit for accessing an optical disk comprising:

a plurality of light sources, each light source generating a beam of light at a different wavelength, in a first state of polarization;

at least one beam combiner for directing each beam of light along a common path;

a first lens for collimating the beam of light traveling along the common path;

a first reflector for redirecting the beam of light traveling along the common path, the first reflector disposed at a nominal 45° angle of incidence to the common beam path and at substantially ±45° azimuthal angle difference between the first state of polarization and the plane of incidence of the first reflector;

a second reflector for redirecting the beam of light from the first mirror to the optical disk;

a second lens for focusing the beam of light onto the optical disk; and

wherein at least one of the first and second reflectors includes a thin film dielectric retarder stack, whereby reflection off of the first and second reflectors creates a substantially 80° to 100° phase retardance in the beam of light for converting the first state of polarization to a second state of polarization.

### BRIEF DESCRIPTION OF THE DRAWINGS

The invention will be described in greater detail with reference to the accompanying drawings which represent preferred embodiments thereof, wherein:

FIG. 1 is a side view of a conventional multi-wavelength optical pick-up unit;

FIG. 2 is a side view of an alternative conventional multi-wavelength optical pick-up unit;

FIG. 3 is an isometric view of a multi-wavelength optical pick-up unit of the present invention;

FIGS. 4a and 4b are schematic cross-sectional views of alternative embodiments of the optical pick-up units of FIG. 3;

FIG. 5a is an isometric view of the two-mirror beam deflection subsystem of FIG. 3;

FIG. 5b is an isometric view of an alternative embodiment of the two-mirror beam deflection subsystem of FIG. 3;

FIGS. 6a and 6b are cross sectional view of the two-mirror beam deflection subsystems of FIGS. 4 and 5, respectively;

FIG. 7 is an isometric view of an alternative embodiment of the multi-wavlength optical pick-up unit of the present invention;

FIG. 8 is a plot of wavelength vs linear retardance for an aluminum mirror at different angles of incidence; and

FIGS. 9 to 11 are plots of the differences in linear retardance between the two mirrors at different wavelengths.

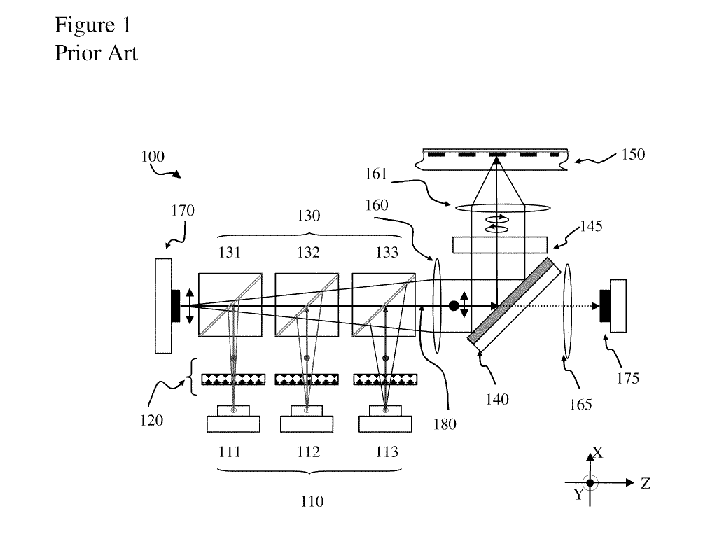

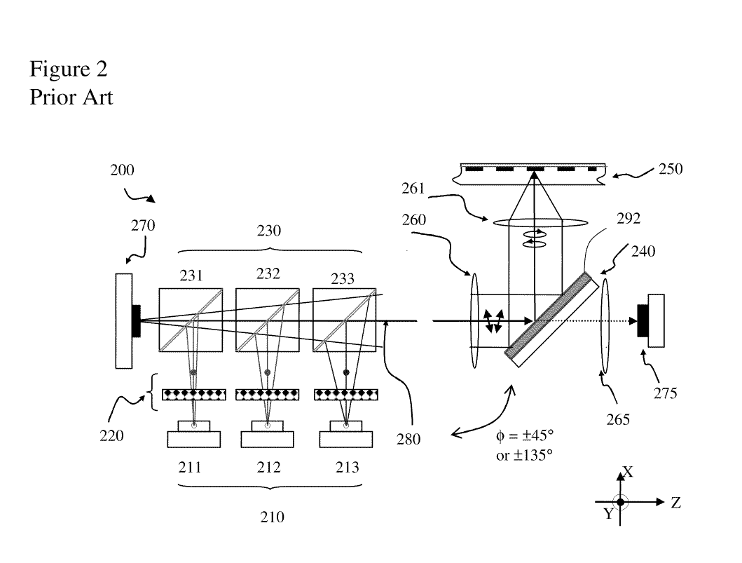

### DETAILED DESCRIPTION

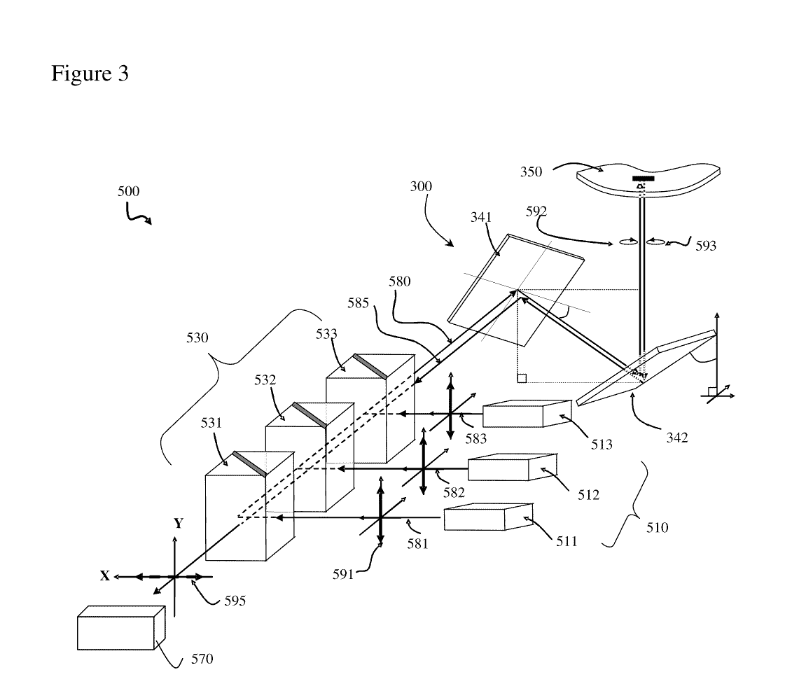

With reference to FIG. 3, the optical pick-up (OPU) system generally indicated at 500, in accordance with the present invention, comprises an array 510 of LD light sources 511, 512 and 513, whose outputs are multiplexed and directed into a common path 580 from an array 530 of polarizing beam combiners (PBC) 531, 532 and 533. The LD source array 510, comprises at least two members corresponding to the multiple discrete solid state light sources, each of which generates an optical beam at a different wavelength for different disc media formats, such as BD, DVD and/or CD, as is well known in the art. Each of the LD sources outputs linearly polarized light, e.g. aligned to the S-polarization of the hypotenuse plane of each PBC 531 to 533. In the illustrated embodiment three light paths 581, 582 and 583 are shown extending from the LD light sources 511, 512 and 513, respectively, for the case of a three-wavelength OPU system as having a first linear (vertical) polarization 591. The first linear polarization is reflected by the PBC array 530 and directed towards a reflective waveplate 341 and a beam deflection sub-assembly.

In contrast to a traditional broadband MacNeille-type polarizing beamspitter cube, which reflects one polarization, e.g., S-pol., and transmits the orthogonal polarization, e.g., P-pol., over a broadband, the array of polarization beam combiners 530 are wavelength dependent. For example, in a forward propagating direction, the first PBC 531 couples light λ₁ from the first LD 511 to the common path 580 by reflecting S-polarized light at λ₁. In a backward propagating direction, the first PBC 531 transmits P-polarized light at λ₁, as well as transmitting the P-polarized light at λ₂ and λ₃, which are associated with LD 512 and 513, respectively. Similarly, the second PBC 532 couples light at λ₂ to the common path 580 by reflecting S-polarized light at λ₂, as well as transmitting S-polarized light at λ₁. For returning light the second PBC 532 transmits P-polarized light at λ₁, λ₂ and λ₃. The third PBC 533 couples light at λ₃ to the common path 580 by reflecting S-polarized light at λ₃, as well as transmitting S-polarized light at λ₁ and λ₂, while transmitting P-polarized light returning at λ₁, λ₂ and λ₃.

The multiplexed LD source is then modulated with a net 90° retardance through a two-mirror sub-system 30 which also deflects the beam to an orthogonal axis at the output. The multiplexed first linear polarization is converted to a first circular polarization at the exit of the two-mirror sub-system 300 and is directed towards the disc media 350. In practice, the net retardance is between 80° and 100°.

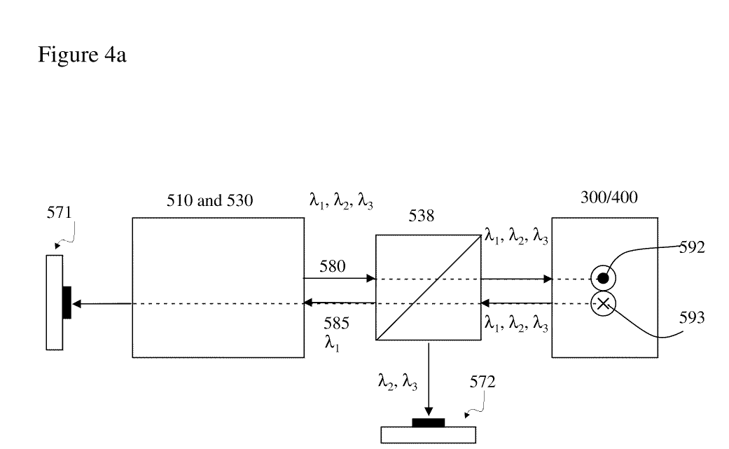

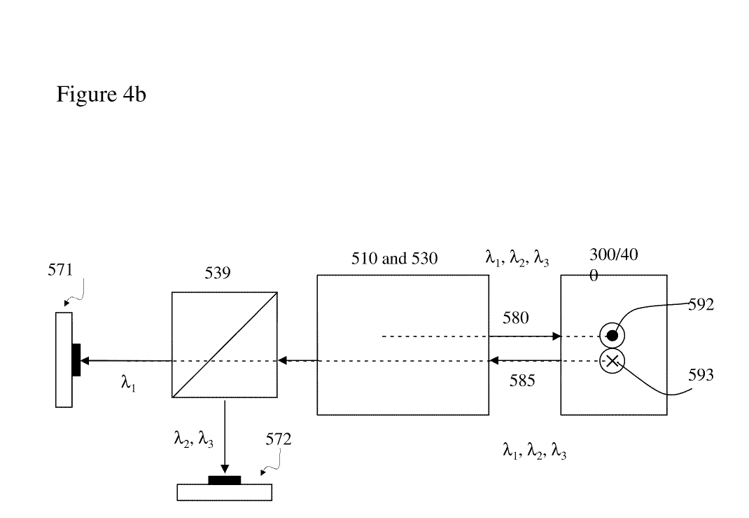

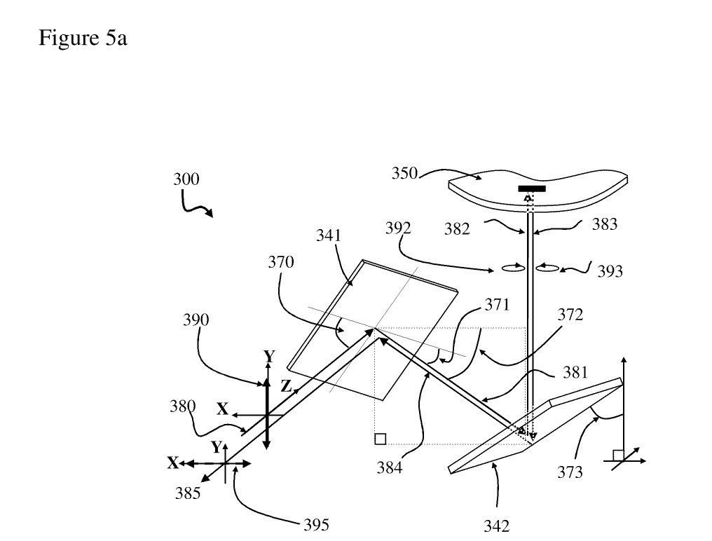

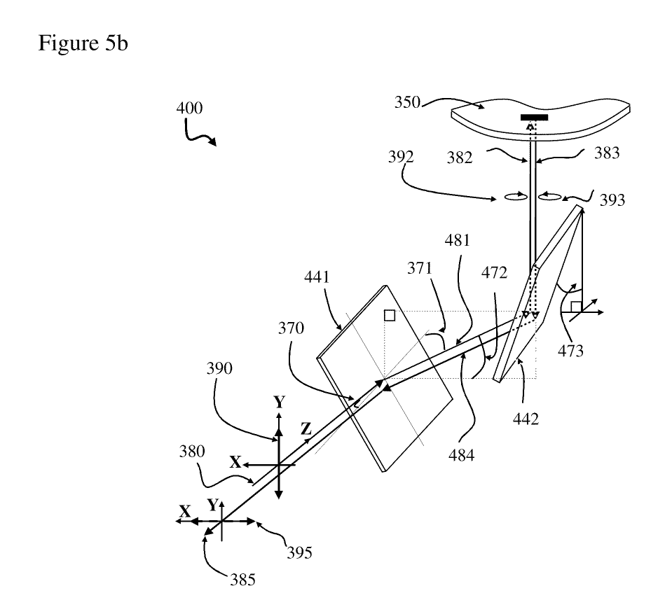

With reference to FIGS. 5a and 5b, which illustrate the two-mirror beam deflector sub-systems 300 and 400, one of the several LD output beams is multiplexed into the common path 380 and pointed in the direction of Z-axis. In the schematic drawing, the first device plane is parallel to XZ plane, which is also typically the horizontal plane. XYZ is the right-handed coordinate system with respect to the first pass beam propagation along the common path from the polarization beam combiners 530 to the two-mirror beam deflector sub-system 300. The common path 380 intersects a first retarder mirror 341/441, inclined at a compound angle tilt. The compound angle is obtained by aligning the first retarder mirror 341/441 at normal incidence vs. the common path 380, rotating the retarder mirror 341/441 about the +X-axis by a first Euler angle θ (typically ±45°) and rotating the tilted mirror 341/441 about the global +Z-axis by a second Euler angle φ at either ±45° or ±135°. The schematics of beam deflections in FIGS. 4 and 5 correspond to a second Euler angle of +135° and +45°, respectively and for a same first Euler angle rotation of 45°. The beam deflections having a second Euler angles of −135°/−45° deg. are not depicted in the schematic diagrams shown here.

The effect of the three-step alignment process is to produce a first deflected beam directed diagonally along a second device plane. The second device plane, which is typically the vertical plane, is orthogonal to the first device plane. The second device plane is depicted by the rectangles with dashed outline in FIGS. 5(a) and 5(b). The first retarder mirror 341/441 at a compound tilt angle makes an angle of incidence, θ, 370 with respect to the global Z-axis. If θ0 is ±45°, the first deflected beam 381/481 is also orthogonal to the common path 380. In the general case, the angle of incidence does not need to be constrained to ±45°. In this general case, the second device plane, while being orthogonal to the first device plane, is not orthogonal to the global Z-axis.

Owing to the ±45° or ±135° second Euler rotation of the first retarder mirror 341/441 about the Z-axis in addition to the ±45° first Euler rotation of the first retarder mirror about the X-axis, the plane of incidence of the first retarder mirror 341/441 is skewed from being parallel/orthogonal to the first linear polarization of the multiplexed LD output by ±45°. The first linear polarization may be parallel or orthogonal to the first device plane. As a result, the LD output in the common path 380 provides for half S-pol. and half P-pol. components illuminating the compound angle tilted first retarder mirror 341/441. The common beam is initially linearly polarized. Hence, there is no phase difference between S-pol. and P-pol. beam components before impinging on the first retarder mirror 341/441. Depending on the retardance of the first mirror 341/441, the output beam 381/481 traveling along the second device plane has its state of polarization modified. This specularly reflected output 381/481 is inclined at an azimuthal angle 372/472 of +135/+45°, respectively, from the first device plane. The first deflected beam also makes an angle 371 with respect to the device plane of the first retarder mirror 341/441 arranged at a compound angle tilt.

The propagation direction of the first deflected beam 381/481 in FIGS. 4 and 5, respectively, has to be corrected in order access the disc media 350 which is positioned parallel to the first device plane. This can be accomplished by intercepting the first deflected beam with a second mirror 342/442. The second mirror 342/442 is inclined with respect to the first device plane at a predetermined tilt angle, such that the second deflected beam 382 is directed orthogonal to the first device plane (i.e. directed vertically). The second deflected beam 382 is subsequently focused onto the disc media 350 in an on-axis cone. The objective lens used for focusing is omitted for simplicity.

The second mirror 342/442 is tilted along the second device plane. The second device plane coincides with the plane of incidence of the second mirror 342/442. The directional angle difference of the first 381/481 and second 382 deflected beams is 45° and 135° for +1350/+45° of second Euler angle rotation, respectively. In order to utilize a second mirror 342/442 to steer the second deflected beam 382 vertically, the second mirror 342/442 must be aligned at half the angular differences (i.e. the device normal of the second mirror bisects the first and second deflected beam directions). Hence, for the schematic diagram show in FIG. 4, the second mirror 342 is tilted at 22.5° with respect to first device plane. Similarly, for the schematic diagram show in FIG. 5, the second mirror 442 is tilted at 67.5° with respect to first device plane. As a result of two beam deflections, the read/write beam is out-coupled at orthogonal direction to the first device plane and directed towards the disc media 350. Hence an objective of arranging for an effective 90° beam folding using the two-mirror deflection sub-system is achieved.

It is evidenced by the layout of the two-mirror beam deflection sub-systems show in FIGS. 4 and 5 that the S-plane (which is orthogonal to the plane of incidence) and the P-plane (plane of incidence) of the first and second mirrors 341/441 and 342/442 are arranged oppositely. The P-plane of the first mirror 341/441 corresponds to the S-plane of the second mirror 342/442 and vice versa. It has been shown that the S- and P-planes of the first mirrors 341/441 make a ±45° azimuthal angle differences vs. the first linear polarization input. Consequently, the P-plane and S-plane of the second mirror 342/442 also make a ±45° azimuthal angle differences vs. the first linear polarization input. Further, it has been stated that the first mirror 341/441 is designed to yield retardance in reflection, which also means that any retardance property designed into the second mirror 342/442 can be accessed by the first deflected beam 381/481.

Accordingly, another objective of the two-mirror deflection sub-system 300/400 arrangement is to provide for a net quarterwave retardance, i.e., 90°, to convert the first linear polarization input to a first circular polarization output. By using dielectric C-plate retarders, the geometry must allow for non-normal incidence and there is an angular difference between the incident first linear polarization 390 and the plane of incidence on the retarder mirrors 341/441 and 342/442. In one embodiment, the required 900 reflected retardance is obtained from the first mirror 341/441 over the predetermined wavelength windows and the second mirror 342/442 yields no retardance over the predetermined wavelength windows. Hence, the linearly polarized common beam is converted into a circular polarization (left- or right-handed) in the first deflected beam 381/481. The design of a reflective thin-film is not constrained by the cross-coupling of intensity and phase properties. Consequently, the dispersion of the constituent thin-film materials can be mitigated such that true achromatic reflected retardance can be obtained over a broadband wavelength range while maintaining a high reflection. For example, the first mirror 341/441 can be designed to produce an achromatic ±90° retardance across each wavelength window at 405 nm, 660 nm and 780 nm (typically with ±2% bandwidth vs. center wavelength), corresponding to the BD, DVD and CD laser lines, respectively. Thus, the objective of transforming a linearly polarized common beam 380 to either a right- or left-handed circularly polarized light 382 has been accomplished. Upon reflection from the disc media 350, reflected light ray 383 propagates from the disc media 350 towards the two-mirror beam deflector sub-system 300/400 in the reverse direction and with its circular polarization converted to the opposite handedness circular polarization. In practice, the net retardance is between 80° and 100°.

Note that, although the handedness of the circular polarization is considered inverted upon reflection at a mirror, the loci of the electric vectors for the incident and reflected light rays have the same sense of revolution in space. In FIGS. 5a and 5b, the circular polarization 392 of the incident beam 382 to the disc media 350 and the circular polarization 393 of the reflected beam 383 from the disc media 350 have been shown with opposite handedness. In actual fact, it's the coordinate system that is reversed, not the sense of the electric vector revolution in space or over time. The opposite arrows shown by 392 and 393 are to explicitly denote handedness reversal and they are not strictly correct to depict the electric vector revolutions in space for the incident and reflected beams.

The reflected beam 383 from the disc media 350 then traverses through the second mirror 342/442 and the first mirror 341/441 as light rays 384 and 385, respectively. The output of the two mirror beam deflector sub-system 300/400 is again parallel to the common path 380, but counter propagating along return path 585. Similar to the first pass, the two-mirror phase shifter and beam deflector 300/400 imposes a 90° retardance on the circularly polarized second pass light ray 383. This retardance converts the circular polarization into a second linear (horizontal) polarization 395. The second linear polarization 395 is orthogonal to the first linear polarization 390 because the common beam has traversed through 180° retardance on a round trip. In practice, the net retardance is between 160° and 200°. If the first linear polarization is utilized to multiplex several LD outputs into the common path 580, the second linear polarization can be utilized to separate the return second pass beams from the first pass beams along the return path 585. The return beam is hence directed through the array of polarizing beam combiners 530 towards one or more photo detector(s) 570 disposed along the return path 585.

Alternatively, as illustrated in FIGS. 4a and 4b, an additional beam splitter 538/539 can be utilized to direct the first light beam λ₁, e.g. Blu-ray beam at 405nm, to a first photo-detector 571, and to direct the second and third light beams λ₂ and λ₃, e.g. DVD beam at 660 nm and CD beam at 780 nm, to a second photo-detector 572. The additional beam splitter 538 can be polarization- and wavelength-dependent and is positioned between the two mirror beam deflector sub-systems 300/400 and the array of polarizing beam combiners 530, as in FIG. 4a. Alternatively, the additional beam splitter 539 can be a wavelength dependent, e.g. dichroic, beam splitter and positioned between the array of polarizing beam combiners 530 and the photo-detectors 571 and 572, as in FIG. 4b.

The layouts of a two-mirror beam deflector sub-systems 300 and 400 in FIGS. 5a and 5b accomplish several objectives:

1) providing a non-normal incidence for the spatially multiplexed beams along the common path (termed common beam) on the first mirror 341/441 so as to utilize the retardance of a dielectric film in reflection,

2) providing a ±45° azimuthal angle difference between the first linear polarization axis 390 of the common beam and the S- and P-plane of the two-mirror deflector sub-system 300/400 so as to present half S-pol. and half P-pol. input light to the first mirror 341/441,

3) converting the first linear polarization 390 of the common beam to a first circular polarization 392 at the exit of the two-mirror beam deflector sub-system 300/400,

4) steering the common beam, directed along the Z-axis and parallel to the first device plane, to out-couple orthogonally with respect to the first device plane and access the disc media 350, and

5) providing the reverse path, via reflection off the disc media, to recapture the beam axis along the common path, but counter propagating and converting the first linear polarization 390 to a second orthogonal linear polarization 395 for the return beam having traversed the two-mirror beam deflector sub-system 300/400 twice in opposite directions.

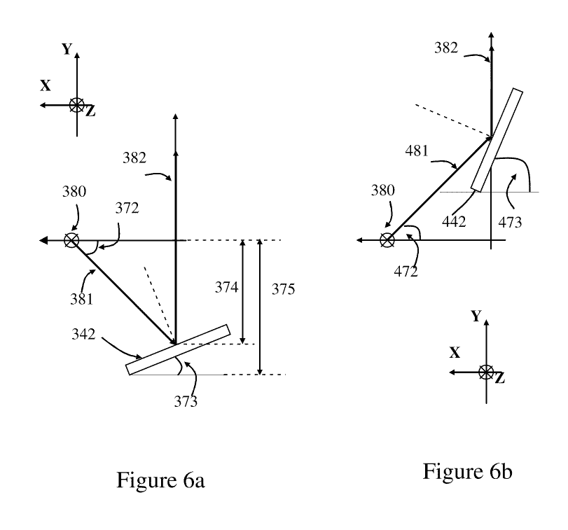

The beam deflections accorded by +135/+45° second Euler rotations are shown by the cross-sectional views in FIGS. 6a and 6b. In FIG. 6(a), the second Euler rotation angle about the Z-axis is +135° whereas in FIG. 6(b), the second Euler rotation angle about the Z-axis is +45°. In both diagrams, the first Euler rotation angle of the first mirror 341/441, aligned initially normal to the common beam 380, is 45°. As a result of the first and second Euler rotations, the first deflected beam is contained within the XY plane and aligned along the diagonal axes. Two other cases of −135/−45° second Euler rotation about the Z-axis with respect to a RH-XYZ coordinate system are not shown here. Starting from the common beam 380, which propagates along +Z-axis in the first pass, the observer sees the tail end of the beam, represented by the \textcircled{x} symbol in both FIGS. 6(a) and 6(b). The common beam 380 is aligned parallel to the first device plane, i.e. the horizontal plane XZ. The first mirror 341/441 is inclined at 45° vs. the common beam 380. Hence, the first reflected beam 381/481 is orthogonal to the incident beam 380. The first mirror 341/441 is also rotated about the Z-axis by +135/+45°. As a result, the sub-system 300 steers the first deflected beam diagonally downwards as 381, while the sub-system 400 steers the first deflected beam 380 diagonally upwards as 481. In both cases, the first deflected beam 381/481 makes an angle difference of ±45° with respect to the first device plane. Subsequently, the position of the second mirror 342/442 has to be adapted such that the second deflection is directed parallel to the vertical axis, i.e. the Y-axis, which requires the second mirror 342 and 442 in sub-system 300 and 400, respectively, to be aligned at 22.5° 373 and 67.5° 473, respectively, with reference to first device plane. The angle of incidence on the second mirror 342 is nominally 22.5° and that of the second mirror 442 is nominally 67.5°. Both beam deflection schemes direct the output beam of the two-mirror sub-system 300/400 along the Y-axis to access the disc 350. The disc 350 is typically aligned parallel to the first device plane, i.e. XZ plane.

The diagonal beam deflection after the common beam 380 is reflected from the first mirror 341/441 takes up additional height for the OPU assembly 500. For a maximum beam diameter of between 2 mm to 3 mm at the common path section 380 and a first and second mirror diameter of 4 mm, the additional vertical walk-off can be estimated for the case of sub-system 300 as follows with reference to FIG. 6a:

vertical height 374 to the second mirror 342=4 mm,

vertical distance of the second mirror 342 having a 2 mm thickness=2/cos(22.5°), and

total vertical distance 375 from center of beam 380 to package base=4+2/cos(22.5°)+2*sin(22.5°) which is approximately 7 mm.

Note that in a conventional OPU assembly with a package height of approximately 10 mm, the common path 380 is already located at approximately 5 mm off the base of the package. The twice deflected beam steering scheme merely adds 2 mm of extra height requirement.

The beam deflection scheme that allows for the replacement of a vertical fold mirror and a transmissive QWP sub-system with the two-mirror net QWP sub-system 300 or 400 has been described in the above. The first mirror 341/441 can be designed as a reflective QWP while the second mirror 342/442 can be designed as a regular metallic reflector. The all-inorganic first mirror 341/441 is flexible, durable, highly reliable for high light exposure and potentially low cost for polarization conversion applications. The second metallic mirror 342/442 can be the conventional low cost reflector, imparting zero to very low phase changes to the reflected light.

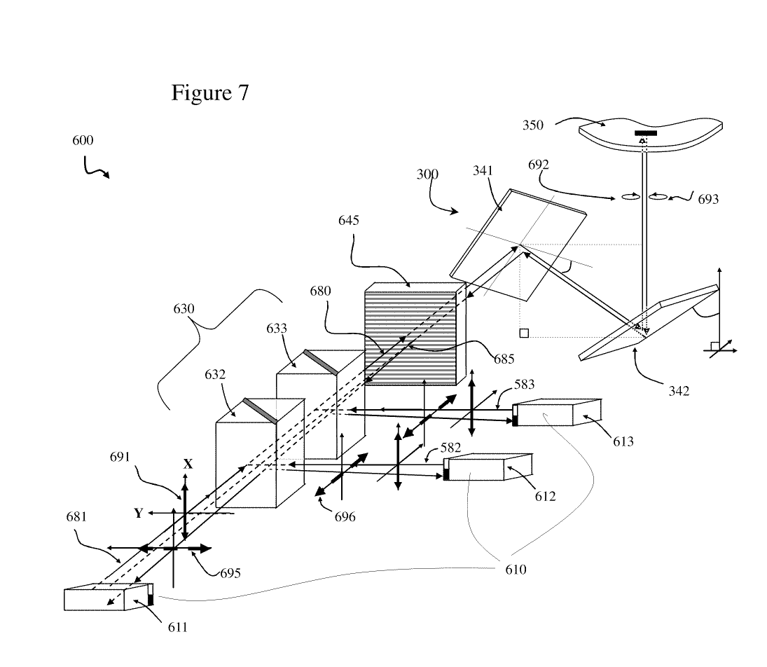

With reference to FIG. 7, another embodiment of an OPU system 600 in accordance with the present invention comprises an array of integrated source/detector units 610, an array of dichroic beam combiners 630, a two-mirror phase shifter and beam deflector 300′, a polarizing hologram 645 and a rotating optical disc 350. The major optical components, such as the array of integrated source/detector units 610 and the array of dichroic beam combiners 630 are arranged to populate a first device plane. The optical disc 350 is also aligned parallel to the first device plane. In the co-pending United States Patent Publication 2008/0049584 for an OPU layout incorporating co-packaged LD/PD, DBC array, polarizing hologram and a reflective QWP and fold mirror, the linear polarization output of the LD arrays has to be aligned at ±45 deg. with respect to device plane. While this can potentially be implemented, the issues arise from the packaging LD/PD integrated unit in a compatible way for conventional OPU systems utilizing a transmissive achromatic QWP and alternate OPU systems utilizing reflective quarterwave retarders. In the conventional OPU layout, the packaged LD/PD units are aligned with their facets parallel and orthogonal to the first device plane. Each laser emitter output is also arranged to be parallel or orthogonal to the first device plane. The present invention provides for a utility to allow for the use of dielectric reflective quarterwave retarder in conjunction with an array of LD output polarizations aligned either parallel or orthogonal to the first device plane.

The array of integrated source/detector units 610 includes a first member 611, a second member 612, and a third member 613. Each integrated unit includes a light source, such as a LD, and a co-packaged photodetector, such as a photodiode (PD). The array of integrated units 610 provides the linearly polarized light beams at each of the OPU wavelengths, e.g., at 180 nm, 660 nm, and 405 nm, respectively. Alternatively, the array 610 includes more or less than three integrated units.

The array of dichroic beam combiners (DBCs) 630, which include a first member 631, a second member 632, and a third member 633, is used to spatially multiplex the output from the integrated array 610 and directs it along a common light path 680. Each DBC 631/632/633 uses the dichroic interface sandwiched between two prisms to transmit or reflect light from the integrated array 610. Note that the DBCs 630 are not polarization beam splitting cubes, but rather function as a type of dichroic band-pass filter to transmit and/or reflect the incident light in dependence upon the wavelength.

The two-mirror phase shifter and beam deflector 300′ redirects light transmitted from the DBCs 630 to the rotating optical disc 350. The two mirror sub-system 300′ is similar to those described as 300 and 400; however, only the 300 scheme is shown in FIG. 7. The two-mirror sub-system 300′ comprises thin-film coatings that provide substantially quarterwave retardation at the three OPU wavelengths, e.g., 405 nm, 660 nm and 780 nm. According to one embodiment, the thin film coating includes a plurality of alternating layers having contrasting refractive indices that are incorporated into a filter, e.g. short-wave pass or long-wave pass, band pass, high reflection, etc., and deposited on a substrate. In another embodiment, the high reflector redirects substantially all incident light, S-pol. and P-pol., to the orthogonal beam path towards the optical disc 350.

The polarizing hologram 645 is designed to diffract light reflected from the optical disc 350 at one or more different wavelengths, e.g., at 780 nm, 660 nm, and 405 nm, so that the return beams are directed to the PD portion of the integrated units 611, 612 and 613 rather than the LD portion. Polarizing holograms, which for example may include a diffraction grating formed on a birefringent substrate, are well known in the art, and are not discussed in further detail. It is noted that polarization selective linear directions of the polarizing hologram 645 are aligned parallel to the first linear polarization for non-diffraction in the first pass, and parallel to the second linear polarization for diffraction in the second pass. In general, the diffraction plane (also grating vector) of the polarizing hologram 645 can be configured to any arbitrary azimuthal plane. Advantageously, the diffraction plane is aligned parallel or orthogonal (as shown in FIG. 7) to the first device plane. In this case, the polarization selective directions are aligned orthogonal or parallel to the grating lines of the polarizing hologram 645. This diffraction plane configuration enables co-packaged LD and PD integrated units 611, 612 and 613 to be mounted regularly in the OPU system 600 vs. the OPU package rectangular cross-section.

In operation, the first linearly polarized light of the first wavelength λ₁ from the first integrated unit 611 is transmitted through the array of DBCs 630 and directed along common optical path 680. Similarly, first linearly polarized light of the second wavelength λ₂ from the second integrated unit 612 is reflected from the first DBC 632, passed through the second DBC 633, and directed along common optical path 680. Finally, first linearly polarized light of the third wavelength λ₃ from the third integrated unit 613 is reflected from the second DBC 633 and is directed along common optical path 680. The multiplexed linearly polarized light, along the common path 680, is then collimated by a lens (not shown), passed through polarizing hologram 645 undiffracted, and deflected by the two-mirror phase shifter 300′ having achromatic QWP coating. The two-mirror sub-system 300′ transforms the first linearly polarized light into a first circularly polarized light and redirects it to the optical disc 350 via the objective lens (not shown). Light reflected by the optical disc 350 is retransmitted through the objective lens (not shown) and is deflected from the two mirror sub-system 300′ through the polarizing hologram 645 towards the collimating lens (not shown). Since the achromatic QWP coating converts the polarization state of the first linearly polarized light into a second orthogonal linear polarized light upon double passing there through, the polarizing hologram 645 diffracts the return light so that its optical path is slightly shifted. The deviated second linearly polarized light is imaged onto the photodiode portion of the respective integrated unit 611, 612 or 613. The DBCs 632 and 633 are a low- and high-pass filters, which either transmit or reflect both S-pol. and P-pol. as a function of the wavelength in both the forward and reverse light passes.

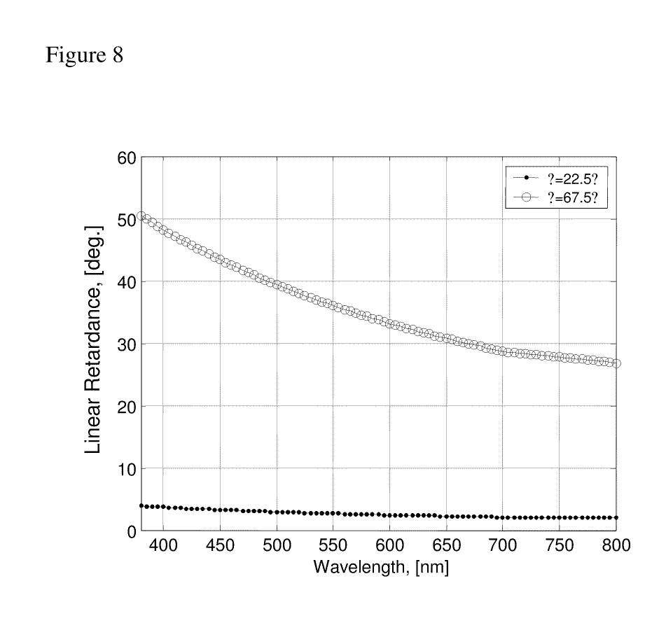

In a general case, the combined net retardance of the two-mirror sub-system 300′ is required to be 90° and its retardation axis is oriented at ±45° azimuthal angle offset vs. the first linear polarization. The retardation axis may assume a different sign of angular orientation over a different wavelength window. The individual mirror retardances, however, do not have to be either 90° or 0° retardance. For example, it's is well known that if the second mirror is fabricated as a metallic reflector, the off-axis reflection from the metallic mirror has a phase difference between the P-pol. and S-pol., i.e. has a retardance. An example calculation results of reflected retardance at 22.5° and 67.5° AOI onto an aluminum mirror are shown in FIG. 8. These two angles of incidence correspond to the second mirror alignment in two-mirror sub-systems 300 and 400, respectively. It is shown that a beam at the shallower angle of incidence accumulates a few degrees of retardance upon reflection. The retardation convention here refers to the phase difference of the e-wave (also the P-pol.) vs. the o-wave (also the S-pol.) and the phase convention of Abeles is adopted. Per Abeles phase convention, an ideal mirror has zero degree of phase difference between two orthogonal linear polarizations at normal incidence. Referring now to the 3-wavength reflective QWP design depicted in FIG. 15 of United States Patent Publication 2008/0049584, the retardance values between the e-wave and o-wave are +90/−90/+90° at the three OPU wavelengths, 405, 660 and 780 nm, respectively.

The designs of the two mirror sub-system 300/400 may allow for the required ±90° phase retardance to be distributed over the two mirrors coatings. Thus, in the general case, the reflected retardance of the first and second mirrors 341/441 and 342/442 does not have to be ±90° and 0°, respectively or vice versa. Nor do the first and the second mirrors 341/441 and 342/442 have to achieve +45° and −45° retardance, respectively, upon reflection at the required angle of incidence for proper beam deflection. Any combination of two constituent retardance values at the required angles of incidence of these two mirrors that yields a net retardance of ±90° is sufficient requirement to convert the first linear polarization to a first circular output polarization. The circular output polarization can be left- or right-handed. The handedness of the circular polarization does not matter for a double-pass system. Upon passing the two-mirror sub-system 300/400 twice, a second linear polarization results. The second linear polarization is orthogonal to the first linear polarization. According to the OPU system layout 500 in FIG. 3, the second linear polarization is separated from the first linear polarization by the array of polarizing beam splitters 530. According to the OPU system layout in FIG. 7, the second linear polarization causes the polarizing hologram 645 to diffract the light beam in second pass. The diffraction steers the return light beam away from the beam path in the first pass. The spatially separated return beam is then directed to photodetector(s).

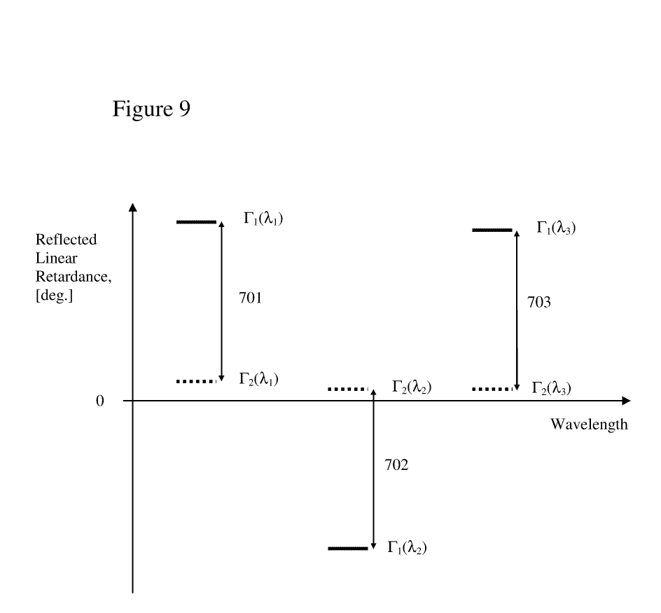

As an example of using the two-mirror sub-system 300/400 according to the present invention to phase shift and deflect the common beam 380 to the disc media 350, the second mirror 342/442 can be designed as regular aluminum reflector while the first mirror 341/441 can be re-optimized to account for the offsetting retardance of the second mirror 342/442. Owing to the plane of incidence reversal on successive incidence at the first mirror 341/441 and the second mirror 342/442, the net reflected retardance is the difference between the first reflected retardance and the second reflected retardance. The first reflected retardance, imparted by the first mirror 341/441 and the second reflected retardance imparted by the second mirror 342/442 are both defined by taking the phase difference of the e-wave vs. the o-wave with respect to the local plane of incidence. Taking the base design as shown in FIG. 15 of United States Patent Publication 2008/0049584 and the aluminum reflector retardance, the new first mirror design is required to produce retardance targets in all three wavelengths as shown in FIG. 9. In the first wavelength window (λ₁), the first mirror 341/441 produces Γ₁(λ₁) retardance whereas the second mirror 342/442 produces Γ₂(λ₁) retardance; in the second wavelength window (λ₂), the first mirror 341/441 produces Γ₁(λ₂) retardance whereas the second mirror 342/442 produces Γ₂(λ₂) retardance and in the third wavelength window (λ₃), the first mirror 341/441 produces Γ₁(λ₃) retardance whereas the second mirror 342/442 produces Γ₂(λ₃) retardance. The design and fabrication target is to produce a difference in retardance of the first mirror 341/441 and the second mirror 342/442 within each wavelength window that is equal to ±90°: In practice, the net retardance is between 80° and 100°.

Γ₁(λ₁)−Γ₂(λ₁)=±90°;

Γ₁(λ₂)−Γ₂(λ₂)=±90°, and

Γ₁(λ₃)−Γ₂(λ₃)=±90°.

The retardance differences of the first and second mirrors 341/441 and 342/442 across each of the three wavelength windows are shown by the vertical value differences in 701, 702 and 703 in FIG. 9. With reference to the local plane of incidence, each mirror retardance is obtained by the Abeles phase of P-pol. (also the e-wave) minus the Abeles phase of S-pol. (also the o-wave). The phase difference of each mirror yields retardance. In the two-mirror phase shifter and beam deflector sub-system 300/400, the local planes of incidence are reversed from the first mirror 341/441 to the second mirror 342/442. Consequently, the retardance difference of the two mirrors yields a net retardance of the sub-system 300/400.

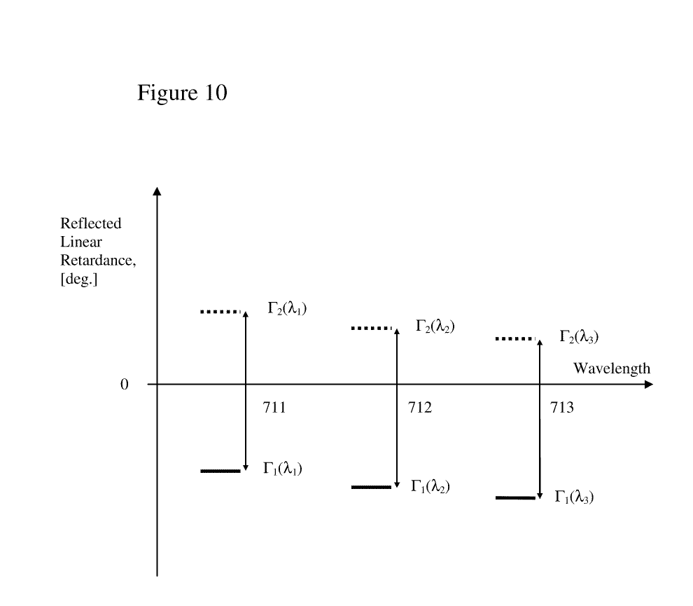

The above example of obtaining ±90° net retardance pertains to the second mirror 342/442 yielding only a small amount of reflected retardance. Such a device characteristics could be obtained for example from aligning a metallic reflector at 22.5° tilt according to the two-mirror sub-system 300. Where the two-mirror scheme 400 is more advantages for imparting phase shifts and beam deflection, coating designs that provide opposite signs of retardation in the two mirrors are more appropriate. This design approach is shown by the individual mirror retardance and retardance difference in FIG. 10. For example, according to the calculation results shown in FIG. 8, the aluminum reflector yields about 47.5° of retardance at 405 nm wavelength with a 67.5° AOI. Consequently, the first dielectric mirror needs only to provide −42.5° of reflected retardance at the required AOI (for example 45°) at 405 nm wavelength. The reversing of plane of incidence on successive reflections of the first and the second mirror yields a net retardance of −90° in this example. Similarly, the coating design of the first mirror 341/441 also yields opposite sign retardance than the retardation in the second mirror 342/442 across two other wavelength bands. The required ±90° net retardance is shown by the device retardance differences 711, 712 and 713, for the first, second and third wavelength windows, respectively. It is unlikely that two metallic mirrors can be cascade together to provide for the net ±90° phase shifting and beam deflection function. Without utilizing the interference property of a dielectric reflector film stack, the retardance dispersion cannot be effectively mitigated. Hence, at least one of the two retarder mirrors 341/441 or 342/442 requires an inorganic dielectric film stack to be applied either on a transparent/opaque substrate or on another metallic reflector. In this manner, the achromaticity of the quarterwave retardance can be achieved.

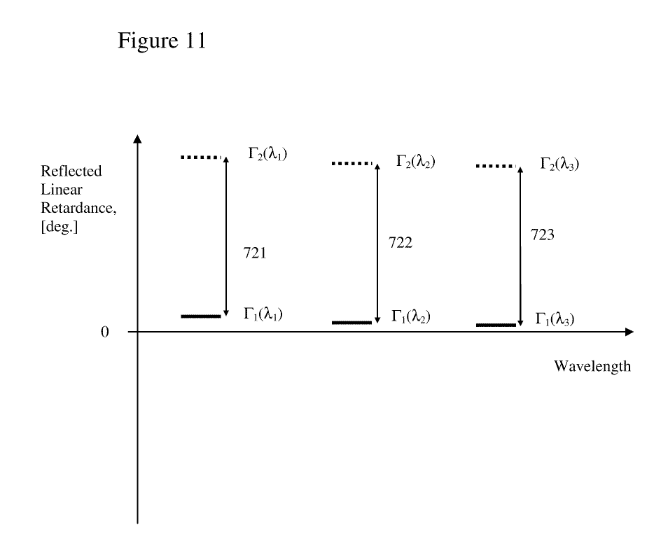

It is also possible to reverse the role of the two mirrors. For example, the first mirror 341/441 can be tilted in a compound angle manner in order to setup the ±45° azimuthal angle difference between the first linear polarization axis and the local mirror plane of incidence. This mirror imparts only a small amount of retardance to the reflected beam. The second mirror 342/442, working in concert with the first mirror 341/441, deflects the beam to the disc media 350 and provides for the bulk of the ±90° retardance. The individual mirror retardance values are shown in FIG. 11. The retardance differences are depicted by 721, 722 and 723 in each of the three OPU wavelength windows.

The two-mirror phase shifting and beam deflection sub-system 300/400 has been described to enable the conversion of linear to circular polarization and vice versa, and to steer the common beam 380 out of the single device plane of the conventional OPU layout in an orthogonal direction so as to access the optical disc. At least one of the two mirrors 341/441 and 342/442 is coated with a dielectric stack, which yields retardation properties at two or more OPU illumination wavelengths. Alternatively, the phase shifting and beam deflection sub-system 300/400 comprises two or more mirrors, with at least one mirror fabricated using a dielectric thin film stack. The two-mirror sub-system 300/400 is aligned in a compound angle tilt such that there is a ±45° angular difference between the linear polarization input and the local plane of incidence at each of the mirrors 341/441 and 342/442. The polar angle differences of the plane of the first mirror 341/441 and the common beam axis 380 is nominally 45°; however, any suitable off-axis illumination of the first mirror 341/441 in order to access the retardance of the first mirror 341/441 is sufficient. Two second Euler rotations of the first mirror 341/441 about the common beam axis at +135° and +45° have been depicted with schematic diagrams. It is expected that other second Euler rotations, such as −135° and −45° are applicable for the invention as well. Further, the second Euler rotation of the first mirror element 341/441 results in approximately equal S-pol. and P-pol. waves at the first mirror incidence. It is understood that depending on the optical layout and the desired distribution of S-pol. and P-pol. input fractions, the second Euler rotation can result in slightly non-diagonal beam deflection after passing through the first mirror 341/441. In order words, the second Euler angle of the first mirror 341/441 may deviate slightly from the ±45° and ±135° rotations, which could, for example, be used to compensate for the slight diattenuation of the S-pol. and P-pol. reflectance of the mirror coatings.

It is further anticipated that the two-mirror phase shifting and beam deflection arrangement is equally applicable for imparting a net 90° retardance for a two wavelength OPU systems, such as one that covers the legacy DVD and CD disc formats. The invention, although is applicable, is unnecessarily more complex for a single wavelength system. In a single wavelength system, multiple technologies such as birefringent crystal plates and form birefringent gratings can be used as transmissive quarterwave retarders. These devices are targeted for single band 90° retardance and are reliable even for short wavelength 405 nm illumination.

The invention specifically relates to a two-mirror subs-system 300/400 and a method of realizing an effective ±90° phase retardance, while deflecting the common beam 380 to access the optical disc 350, and OPU system that incorporates the two-mirror phase shifter and beam deflector sub-system 300/400. The OPU system may comprise an array or polarization beam combiners, dichroic beam combiners or a combination of both polarization and dichroic beam combiners. In the OPU system, the device plane formed by joining the propagation axes from an array of LDs to an array of beam combiners is arranged parallel to the optical disc. The required approximately half S-pol. and half P-pol. power distribution for inputting into the two-mirror phase shifter and beam deflector sub-system is implemented by titling the first retarder mirror in a compound angle manner and the second mirror arranged in concert to correct for the beam deflection and the reflective retardance property after the first mirror. The OPU system relies on the conventional arrangement of LD and beam combiner arrays while enabling the use of a high reliability and durable inorganic reflective quarterwave retarder to convert the linear polarizations in the source/detector segment and the circular polarizations in the disc read/write segment.

The optical pick-up systems in accordance with the present invention can be used exclusively for reading the optical disk media, for writing onto the disk media, or for both reading and writing, i.e. accessing, the disk media. The photo-detectors can be omitted from the OPU's used only for writing.

We claim:

1. An optical pick-up unit for accessing an optical disk comprising:
a plurality of light sources, each light source generating a beam of light at a different wavelength, in a first state of polarization;
at least one beam combiner for directing each beam of light along a common path;
a first lens for collimating the beam of light traveling along the common path;
a first reflector for redirecting the beam of light traveling along the common path, the first reflector disposed at a nominal 45° angle of incidence to the common beam path and at substantially ±45° azimuthal angle difference between the first state of polarization and the plane of incidence of the first reflector;
a second reflector for redirecting the beam of light from the first mirror to the optical disk; and
a second lens for focusing the beam of light onto the optical disk;
wherein at least one of the first and second reflectors includes a thin film dielectric retarder stack, whereby reflection off of the first and second reflectors creates a substantially 80° to 100° phase retardance in the beam of light for converting the first state of polarization to a second state of polarization.

2. The optical pick-up unit according to claim 1, wherein the separate paths and the common path define a first plane;
wherein the first reflector redirects the beam of light downwardly out of the first plane to the second reflector; and
wherein the second reflector redirects the beam of light upwardly, perpendicular to the first plane towards the optical disk.

3. The optical pick-up unit according to claim 1, further comprising at least one photo-detector for receiving returning light reflected back via the first and second reflectors.

4. The optical pick-up unit according to claim 3, wherein reflection from the optical disk converts the second polarization to a third polarization;
wherein reflection from the first and second reflectors, a second time in an opposite direction, converts the third polarization to a fourth polarization, which is orthogonal to the first polarization;
wherein the plurality of light sources comprises a first light source at a first wavelength, and a second light source at a second wavelength;
wherein the at least one beam combiner includes a first wavelength dependent polarization beam combiner (532) for transmitting the first wavelength at the first and fourth polarizations, and the second wavelength at the fourth polarization along the common path, and for reflecting the second wavelength at the first polarization from the second light source to the common path.

5. The optical pick-up unit according to claim 4, wherein the plurality of light sources also includes a third light source at a third wavelength; and
wherein the at least one beam combiner also includes a second wavelength dependent polarization beam combiner (533) for transmitting the first and second wavelengths at the first and fourth polarizations and the third wavelength at the fourth polarization along the common path, and for reflecting the third wavelength at the first polarization from the third light source to the common path.

6. The optical pick-up unit according to claim 5, wherein the at least one photodetector comprises a first photo-detector disposed along the common path; and
wherein the at least one beam combiner also includes a third polarization beam combiner (531) for transmitting the first, second and third wavelengths at the fourth polarization along the common path to the single photodetector, and for reflecting the first wavelength from the first light source along the common path.

7. The optical pick-up unit according to claim 6, further comprising:
a second photo-detector for receiving at least one of the first, second and third wavelengths at the fourth polarization; and
an additional beam splitter for directing at least one of the first, second and third wavelengths of the returning light at the fourth polarization to the second photo-detector, while transmitting the other of the first, second and third wavelengths at the fourth polarization to the first photo-detector.

8. The optical pick-up unit according to claim 3, wherein reflection from the optical disk converts the second polarization to a third polarization;
wherein reflection from the first and second reflectors, a second time in an opposite direction, converts the third polarization to a fourth polarization, which is orthogonal to the first polarization;
wherein the plurality of light sources comprises a first light source at a first wavelength, and a second light source at a second wavelength;
wherein the at least one photodetector includes a first photodetector disposed adjacent the first light source, and a second photodetector disposed adjacent the second light source;
wherein the at least one beam combiner includes a first dichroic beam combiner (632) for transmitting the first wavelength at the first and fourth polarizations along the common path, and for reflecting the second wavelength at the first and fourth polarization between the second light source, the common path and the second photodetector.

9. The optical pick-up unit according to claim 8, wherein the plurality of light sources also includes a third light source at a third wavelength;
wherein the at least one photodetector includes a third photodetector disposed adjacent the third light source; and
wherein the at least one beam combiner also includes a second dichroic beam combiner (633) for transmitting the first and second wavelengths at the first and fourth polarizations along the common path, and for reflecting the third wavelength at the first and fourth polarizations between the third light source, the common path and the third photodetector.

10. The optical pick-up unit according to claim 9, further comprising a polarization dependent diffraction element for redirecting the first, second or third wavelengths of returning light at the fourth polarization to wards the first second or third photodetector, respectively.
